(19) United States
(12) Patent Application Publication
(10) Pub. No.: US 2019/0129233 A1
(43) Pub. Date: May 2, 2019

(54) Block Having Phase Change Material and Backlight Module and Display Device Using the Same

(71) Applicant: AU OPTRONICS CORPORATION, Hsin-Chu (TW)

(72) Inventors: Tzu-Chiang Cheng, Hsin-Chu (TW); Wu-Chang Tsai, Hsin-Chu (TW); Ren-Mei Tseng, Hsin-Chu (TW)

(21) Appl. No.: 16/166,901

(22) Filed: Oct. 22, 2018

(30) Foreign Application Priority Data
Nov. 2, 2017 (TW) 106137977

(51) Int. Cl. G02F 1/1333; G02F 1/1335; F21V 8/00

(52) U.S. Cl. CPC G02F 1/133308; G02F 1/133608; G02F 2001/133317; G02F 2001/133322; G02B 6/0088

(57) ABSTRACT

A block, and a backlight module and a display device using the block are provided. The block includes a capsule enclosing a cavity therein and a phase change material received in the cavity. The capsule is at least partially made of an elastic material. The phase change material has a melting point lower than the elastic material. The backlight module includes an optical film, a frame at least partially surrounding a side of the optical film, and the block disposed between the side of the optical film and the frame. The display device includes a display panel, a frame having an accommodation area for accommodating the display panel, and the block disposed between the display panel and the frame.

### FIELD OF THE DISCLOSURE

The present disclosure generally relates to a display device and a backlight module. Particularly, the present disclosure relates to a display device and a backlight module having a block.

### DESCRIPTION OF THE PRIOR ART

Flat display devices and curved display devices are widely applied to a variety of electronic devices, such as mobile phone, personal wearable device, television, host computer for transportation equipment, personal computer, digital camera, palm gaming device, and so on. However, in order to improve the user's visual experience, the industry is still constantly improving the optical performance of the display device.

For a conventional display device, sheet-like elements, such as the display panel or the light guide plate, are generally supported by a plastic frame. In order to position the relative location between the sheet-like elements and the plastic frame, a solid positioning block, which extends from or is formed by the plastic frame or the sheet-like elements, is usually disposed between the sheet-like elements and the plastic frame, so as to prevent excessive movement of the sheet-like elements. However, heat sources, such as light source disposed inside the display device, cause increase in ambient temperature during operation, resulting in thermal expansion of the sheet-like elements. When the sheet-like element is thermally expanded against the solid positioning block, the sheet-like element will deform or become arched due to the reaction force provided by the solid positioning block, impairing the display quality or optical performance.

### SUMMARY OF THE DISCLOSURE

It is an object of the disclosure to provide a block, which can reduce the arching or bending of the sheet-like element caused by thermal expansion.

It is another object of the disclosure to provide a backlight module, which can reduce the arching or bending of the sheet-like element caused by thermal expansion, so as to provide a better optical effect.

It is yet another object of the disclosure to provide a display device, which can reduce the arching or bending of the sheet-like element caused by thermal expansion, so as to provide a better display effect.

In an embodiment, the block includes a capsule and a phase change material. The capsule encloses a cavity, and the phase change material is disposed in the cavity. The capsule is at least partially made of an elastic material, and the phase change material has a melting point lower than the melting point of the elastic material. When the ambient temperature falls higher than the melting point of the phase change material and lower than the melting point of the elastic material, the phase change material will gradually change to a melted state (liquid state) or a semi-solid semi-liquid state. At this point, when subjected to an external force, the phase change material will correspondingly flow to the side and force the capsule to extend outward, so the block will become flatter. When the ambient temperature drops below the melting point of the phase change material, the phase change material will gradually solidify to a solid state. When the external force is removed, the capsule will return to its original shape before the phase change material completely becomes solid due to the elasticity of the elastic material. Accordingly, the phase change material will also return to the shape before melting since the cavity return to its original shape.

In another embodiment, the backlight module includes an optical film, a frame, and the block mentioned above. The frame at least partially surrounds a side of the optical film. The block is disposed between the side of the optical film and the frame to accommodate the increased volume of the optical film caused by thermal expansion, so as to reduce the possibility or extent of the optical film arching or bending. In another embodiment, the display device includes a display panel, a frame and the block mentioned above. The frame has an accommodation area for accommodating the display panel. The block is disposed between the display panel and the frame to accommodate the increased volume of the display panel caused by thermal expansion, so as to reduce the possibility or extent of the display panel arching or bending

### BRIEF DESCRIPTION OF THE DRAWINGS

FIG. 1A is a schematic view of an embodiment of the block;

FIG. 1B is a partial cutaway schematic view of an embodiment of the block;

FIG. 2 is a cross-sectional view of an embodiment of the block;

FIG. 3 is a schematic view of the phase change material in melted state or semi-melted state as the ambient temperature increases;

FIG. 4 is a schematic view of the phase change material back to the original state as the ambient temperature drops;

FIG. 5 is a schematic view of an embodiment of the backlight module;

FIG. 6A is a schematic view of FIG. 5 when the optical film thermally expands;

FIG. 6B is a schematic view of FIG. 5 when the optical film contracts;

FIG. 7 is a schematic view of an embodiment of the display device;

FIG. 8 is a schematic view of another embodiment of the display device; and

FIG. 9 is a schematic view of another embodiment of the display device.

### DETAILED DESCRIPTION OF THE PREFERRED EMBODIMENT

In the drawings, the thickness of layers, films, panels, regions, etc., are 15 exaggerated for clarity. Like reference numerals designate like elements throughout the specification. It will be understood that when an element such as a layer, film, region, or substrate is referred to as being “on” or “connected to” another element, it can be directly on or connected to the other element or intervening elements may also be present. In contrast, when an element is 20 referred to as being “directly on” or “directly connected to” another element, there are no intervening elements present.

In addition, the relative terms such as “below” or “bottom” and “above” or “top” may be used herein to describe the relationship of one element to another, as illustrated. It will be understood that the relative terms are intended to encompass different orientations of the device in addition to the orientation shown in the drawings. For example, if the device in the drawings is turned over, the elements described as being “below” the other elements will be oriented on the “upper” side of the other elements. Therefore, the exemplary term “below” may encompass the orientation of “below” and “above” depending on the particular orientation of the drawing. Similarly, if the device in the drawings is turned over, the elements described as being “above” the other elements will be oriented on the “lower” side of the other elements. Therefore, the exemplary term “above” may encompass the orientation of “above” and “below” depending on the particular orientation of the drawing.

“About”, “approximately” or “substantially” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, ±20%, ±10%, ±5% of the stated value. Moreover, “about”, “approximately” or “substantially” as used herein may select a more acceptable range of deviation or standard deviation depending on optical properties, etching properties, or other properties, without applying a standard deviation for all properties.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims.

The present disclosure provides a backlight module and a block used therein. In a preferred embodiment, the backlight module is applied to a display device to provide the light source required for displaying images, but not limited thereto. In other embodiments, the backlight module can be applied to a lamp, which provides plane light, or any suitable electronic devices. The present disclosure also provides a display device and a block used therein. The display device includes but not limited to liquid crystal display devices, organic light-emitting diode (OLED) display devices, inorganic light-emitting diode display devices, quantum dot light-emitting diode display devices, electrophoretic display devices, or any other suitable display devices.

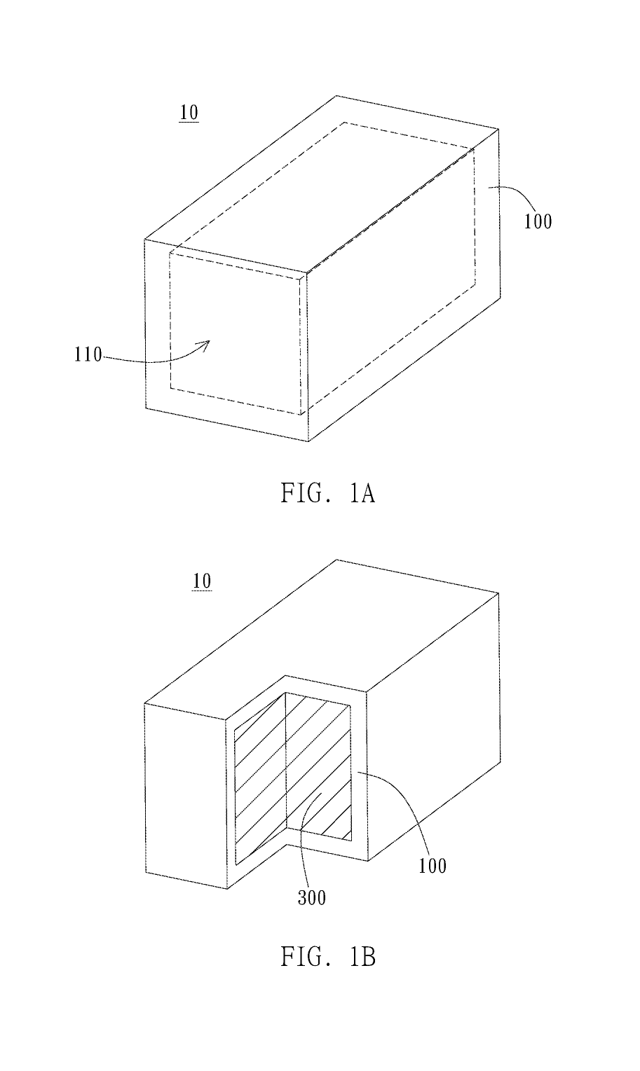

FIG. 1A is a schematic view of an embodiment of a block 10. FIG. 1B is a partial cutaway schematic view of an embodiment of the block 10. As shown in FIGS. 1A and 1B, the block 10 includes a capsule 100 and a phase change material 300. The capsule 100 encloses a cavity 110 therein. The phase change material 300 is disposed in the cavity 110. In this embodiment, the capsule 100 is preferably formed into a hexahedron shape, and rigid lines are formed between the faces, such as a rectangular cuboid. As such, the cavity 110 formed therein preferably also has a hexahedron shape, but not limited thereto. In other embodiments, the capsule 100 may be designed as a polyhedron. For example, from a side view, the polyhedron may have a shape of circle, quadrilateral, trapezoid, triangle, diamond, or oval or any suitable shape. In another embodiment, the thickness of the capsule 100 at a specific portion can be adjusted to increase the structural strength of the capsule 100 at the specific portion, so that the outer shape of the capsule 100 can be different from the contour of the cavity 110. The phase change material 300 is sealed within the capsule 100. In an embodiment, the capsule 100 preferably seals the phase change material 300 therein, but not limited thereto. In another embodiment, the capsule 100 may have a sealable opening for filling or extracting the phase change material 300. In this embodiment, the entire capsule 100 is preferably made of a same elastic material, but not limited thereto. In another embodiment, different portions of the capsule 100 can be made of different materials. For example, the sidewall 130 can be made of a material that is more elastic than other portions or can be modified according to requirements, but not limited thereto.

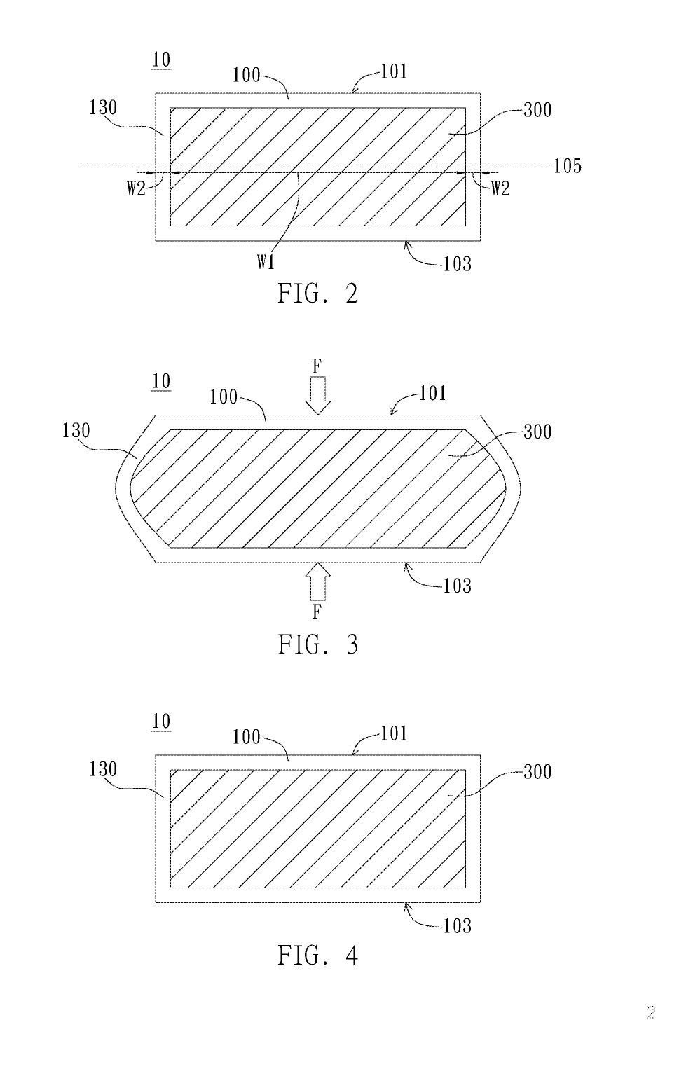

In terms of material properties, the capsule 100 is made of an elastic material or at least partially made of an elastic material. The phase change material 300 has a melting point lower than the melting point of the elastic material of the capsule 100. For example, when the ambient temperature is higher than the melting point of the phase change material 300 and lower than the melting point of the elastic material, the capsule 100 maintains in the solid state and the phase change material 300 is in the melted state (liquid state) or semi-solid semi-liquid state. In a preferred embodiment, the melting point of the phase change material 300 is between 50° C. and 150° C., but not limited thereto. As shown in FIG. 2, when the phase change material 300 is in the solid state for example, the phase change material 300 preferably completely fills the cavity 110, but not limited thereto. In another embodiment, when the phase change material 300 is in the solid state for example, the phase change material 300 can completely fill the cavity 110 and expand the capsule 100 without breaking the capsule 100. Since the cavity 110 is filled with the phase change material 300, when the capsule 100 is subjected to the external force F, the capsule 100 and the phase change material 300 together sustain and share the external force F according to their respective mechanical properties. In a preferred embodiment, when the phase change material 300 is in the solid state, the phase change material 300 has an elastic modulus larger than the elastic modulus of the elastic material. From another point of view, compared with the elastic material, when the phase change material 300 is in the solid state, the phase change material 300 is more rigid and less deformable, so the phase change material 300 provides more supporting force against the external force F. In addition, as shown in FIG. 2, the capsule 100 is in rectangular cuboid shape for example, so the capsule 100 preferably has two surfaces 101 and 103 which are substantially parallel and opposite to each other. In the cross-section 105 which is substantially parallel to the surfaces 101 and 103, the area of the phase change material 300 is preferably larger than the area of the sidewall 130 of the capsule 100. From another point of view, in the dimensions of the cross section 105, the dimension of the phase change material 300 is preferably larger than the dimension of the two sidewalls 130 of the capsule 100, so the area of the phase change material 300 is larger than the area of the sidewall 130 of the capsule 100. For example, as shown in FIG. 2, along the direction indicated by line segment of the cross section 105, the width W1 of the phase change material 300 is larger than the sum of the widths W2 of the two sidewalls 130 (e.g. W1>(2*W2)). Such an arrangement helps the phase change material 300 to provide most of the supporting force against the external force F applied to the surfaces 101 and 103.

As shown in FIG. 3, when the ambient temperature increases, for example exceeds the melting point (or the transition temperature) of the phase change material 300, the phase change material 300 gradually changes to the melted state (liquid state) or semi-solid semi-liquid state. At this point, when subjected to the external force F, the supporting force provided by the phase change material 300 is greatly reduced, and the capsule 100 itself cannot provide sufficient supporting force against the external force F, so the block 10 will deform, in response to the external force F, greater than when the phase change material 300 is in the solid state, and the distance between the surfaces 101 and 103 after deformation is smaller than the distance between the surfaces 101 and 103 before deformation. As shown in FIG. 3, when the block 10 is subjected to the external force F, the phase change material 300 in the melted state (liquid state) or semi-solid semi-liquid state will correspondingly flow to the side and force the sidewall 130 to extend outward, so the whole block 100 is deformed and the space volume occupied by the block 10 along the force direction becomes flatter. That is, when the phase change material 300 is in the melted or semi-melted state, the shape of the phase change material 300 varies with deformation of the capsule 100.

As shown in FIG. 4, when the ambient temperature drops from a temperature between the melting points of the phase change material 300 and the elastic material to a temperature below the melting point of the phase change material 300, the phase change material 300 will gradually solidify to the solid state. Under the condition that the external force F is removed, the capsule 100 will return to its original shape due to the elasticity of the elastic material before the phase change material 300 completely solidifies, and the phase change material 300 will accordingly solidify into the shape before melting according to the shape of restored cavity 110. Moreover, since the capsule 100 of the embodiment has a plurality of rigid lines formed by connecting the faces, these rigid lines also provide the capsule 100 with more stable structure to facilitate the capsule 100 to return to its shape. That is, the phase change material 300 can change from the solid state to the liquid state or from liquid state to solid state as the ambient temperature changes.

In a preferred embodiment, the elastic material has an elastic modulus smaller than 0.1 GPa and greater than 0 GPa, wherein GPa is 1×10⁹ pascals. More preferably, the elastic modulus of the elastic material is between 0.01 GPa and 0.1 GPa. Moreover, the capsule 100 preferably has a tensile strength between 0.01 GPa and 1 GPa. With such arrangements, when the phase change material 300 is in the melted or semi-melted state, the external force F will force the phase change material 300 to push the sidewall 130 outward to generate elastic deformation. When the external force F is removed, the elasticity of the elastic material can enable the capsule 100 to return to its original shape and not easily to generate plastic deformation.

In terms of materials, the phase change material 300 can be selected from organic materials, inorganic materials, any suitable materials, or any of the combinations thereof. When the phase change material 300 is selected from organic phase change materials, the phase change material 300 is preferably selected from compounds of paraffin or aliphatic acids. When the phase change material 300 is selected from inorganic phase change materials, the phase change material 300 is preferably selected from compounds of salt hydrates. Preferably, the phase change material 300 can be selected from but not limited to the following compounds: lauric acid, sodium metasilicate pentahydrate, paraffin 22-34 carbons, bees wax, glycolic acid, p bromophenol, azobenzene, acrylic acid, phenylacetic acid, thiosinamine, bromocamphor, durene, methly bromobenzoate, alpha naphthol, glutaric acid, p-xylene dichloride, catechol, quinone, lactanilide, succinic anhydride, benzoic acid, stilbene, benzamide, any suitable materials, or any of the combinations thereof.

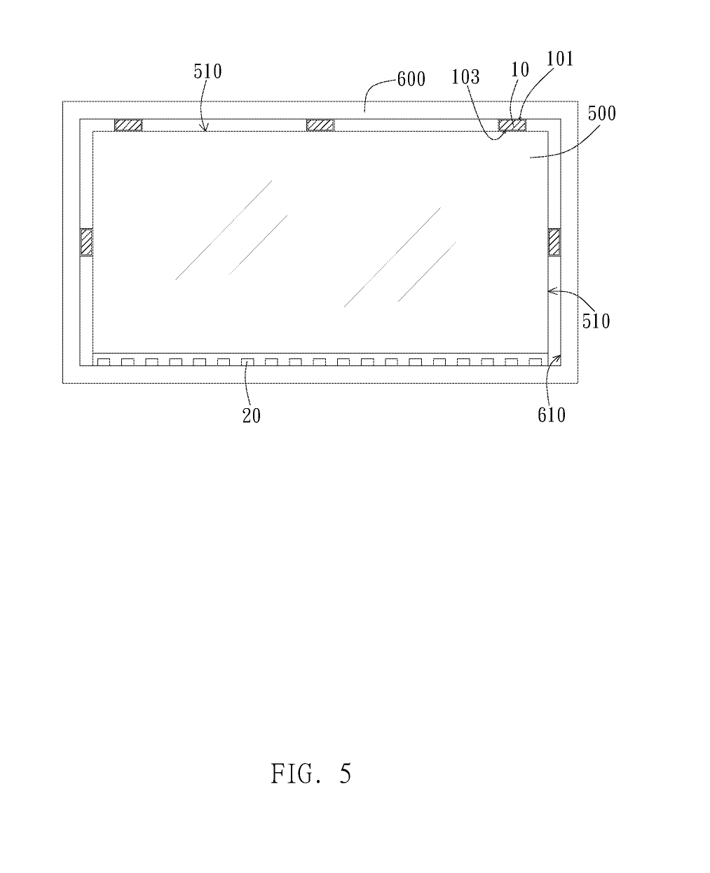

FIG. 5 is a schematic view of an embodiment of the backlight module. As shown in FIG. 5, the backlight module includes an optical film 500, a frame 600, and at least one block 10. The frame 600 can be a closed frame or a semi-opened open frame. The frame 600 at least partially surrounds a side of the optical film 500. The optical film 500 includes a light guide plate (for example but not limited to the light guide plate for medium/small sized display panel), a diffusion plate (for example but not limited to the diffusion plate for large sized display panel), a brightness enhancement film, a reflective brightness enhancement film, a beam-splitting film, a reflective beam-splitting film, a glass substrate, any suitable optical films, or any of the combinations thereof. The glass substrate can be a common substrate shared with the display panel and has optical modulation or optical guidance effect.

As shown in FIG. 5, the backlight module further includes a light source 20. The light source 20 is disposed on one side of the optical film 500. The block can be disposed between the side of the optical film 500 and the frame 600. For example, the blocks 10 are located between the other three sides 510 of the optical film 500 with respect to the light source 20 and the inner wall surface 610 of the frame 600. In another embodiment, the light source 20 can be disposed under the optical film 500. In this embodiment, with the disposition of the blocks 10, the relative location of the optical film 500 and the frame 600 can be positioned and direct impact between the optical film 500 and the frame 600 can be possibly reduced.

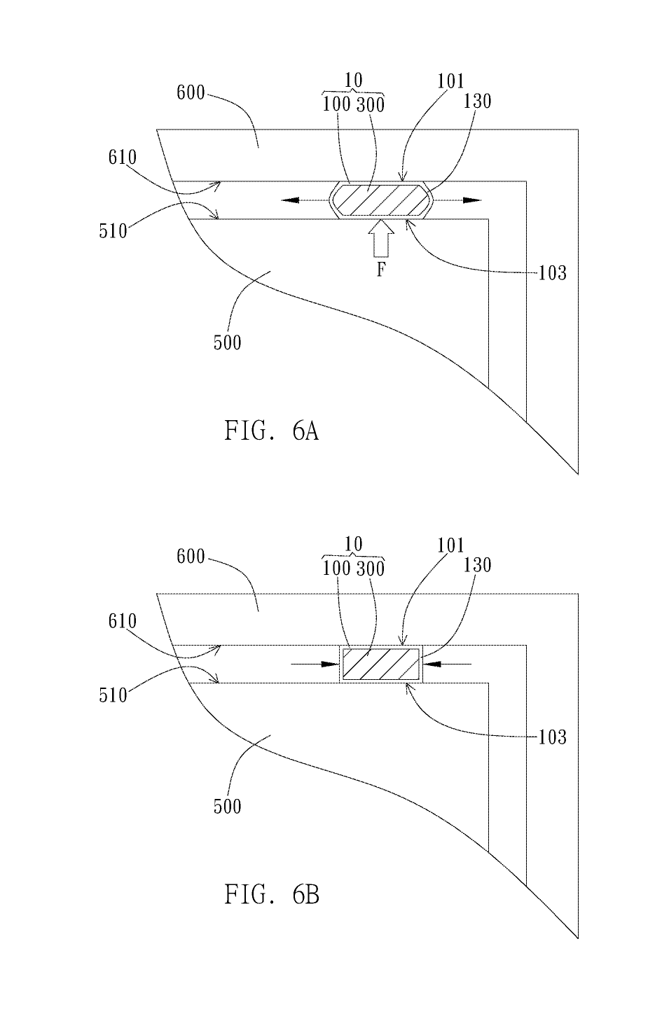

FIG. 6A is a schematic view of FIG. 5 when the optical film thermally expands. Ash shown in FIG. 6A, when the ambient temperature increases for example due to the heat generated by the light source, the optical film 500 will expand due to the heat. Taking a 55-inch display device as an example, if the ambient temperature increases from 25° C. to 60° C., the amount of expansion of the optical film used therein is about 3 mm. In this embodiment, the block 10 is disposed in a manner that the surfaces 101 and 103 of the block 10 face the inner wall surface 610 of the frame 600 and the side 510 of the optical film 500, respectively. When the ambient temperature is at room temperature, the side 510 of the optical film 500 is against the surface 103 of the block 10, and the inner wall surface 610 of the frame 600 is against the surface 101 of the block 10. When the ambient temperature increases, for example, exceeds the melting point of the phase change material 300, the phase change material 300 will gradually change to the melted state (e.g. liquid state) or semi-solid semi-liquid state. At this point, the optical film 500 will also thermally expand to push the surface 103 (i.e. force-exerted surface) and force the sidewall 130 to extend outward, so the distance between the surface 101 and the surface 103 of the block 10 after deformation becomes smaller than the distance between the surface 101 and the surface 103 of the block 10 before deformation. Since the phase change material 300 occupies smaller space along the force-exerted direction after deformation, the pressing force of the block 10 on the optical film 500 is reduced, and the bending or arching of the optical film 500 caused by thermal expansion is also reduced. Therefore, the optical performance of the backlight module is improved.

FIG. 6B is a schematic view of FIG. 5 when the optical film contracts. As shown in FIG. 6B, when the ambient temperature drops below the melting point of the phase change material 300, the phase change material 300 will gradually solidify to substantial solid state. Since the ambient temperature drops, the volume of the optical film 500 is contracted and the pressing force of the optical film 500 on the block 10 is reduced. Under such a condition, the capsule 100 will return to its original shape due to the elasticity of the elastic material before the phase change material 300 completely solidifies, and the phase change material 300 will accordingly solidify into the shape before melting according to the shape of restored cavity 110. Since the capsule 100 and the phase change material 300 both return to the original shape, the capsule 100 and the phase change material 300 can provide the positioning effect of the optical film 500 relative to the frame 600.

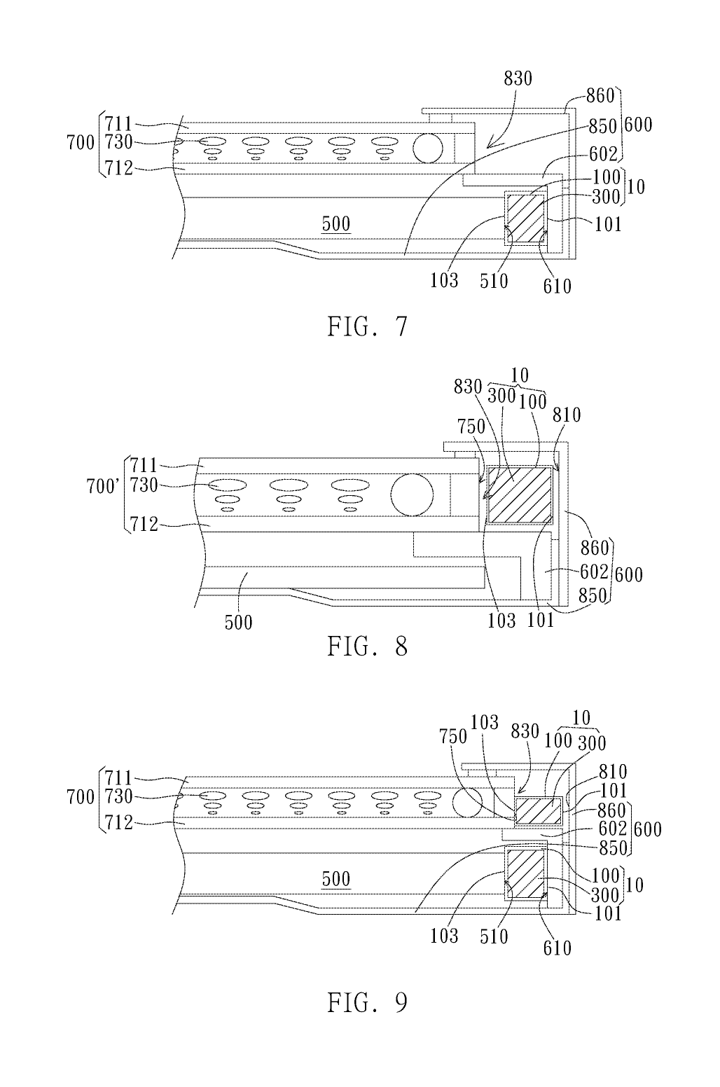

FIG. 7 is a schematic view of an embodiment of the display device. In this embodiment, the display device includes a display panel 700, the frame 600, and at least one block 10. The display panel 700 includes a pair of substrates 711 and 712 and a display medium 730 sandwiched between the pair of substrates 711 and 712. The display panel 700 can further include a polarizer, but not limited thereto. In this embodiment, the display medium 730 can be liquid crystal molecules, so the display device may further include a backlight module as the light source to provide light to the display panel 700 for displaying images. However, in another embodiment, the display medium 730 cam be organic light-emitting diodes, inorganic light-emitting diodes, quantum dot light-emitting diodes, electrophoretic capsules, or any other suitable materials that can be used for displaying images. The backlight module can be a direct-lit or side-lit backlight generation system, and the side-lit backlight generation system is more preferred, but not limited thereto. In this embodiment, the backlight module can include a light source (not shown) and the optical film 500 described above. The optical film 500 can include for example a light guide plate, a diffusion plate, a brightness enhancement film, a reflective brightness enhancement film, a beam-splitting film, a reflective beam-splitting film, and/or a glass substrate. The optical film 500 is preferably disposed under the display panel 700.

As shown in FIG. 7, the frame 600 at least partially encloses an accommodation area 830 for accommodating the display panel 700, and the display panel 700 is partially accommodated in the accommodation area 830. For example, the frame 600 includes a back frame 850, a front frame 860, and a support 602 for supporting the display panel 700. The display panel 700, the frame 600, and the block 10 are disposed in the space defined by the back from 850 and the front frame 860. The support 602 can be a portion of the back frame 850 or a portion of the front frame 860. In another embodiment, the frame 600 of the display device may optionally include only one of the front frame 860 and the back frame 850, instead of having the front frame 860 and the back frame 850 at the same time. The block 10 is disposed between the optical film 500 and the frame 600. For example, the block 10 can be disposed between the side 510 of the optical film 500 and the inner wall surface 610 of the frame 600, so that the surfaces 101 and 103 of the block 10 face the inner wall surface 610 of the frame 600 and the side 510 of the optical film 500, respectively. In an embodiment, the inner wall surface 610 can be the inner wall surface of the support 602, but not limited thereto. In another embodiment, the inner wall surface 610 can be an inner surface of the front frame 860 or the back frame 850. With the disposition of the blocks 10, the relative location of the display panel 700, the backlight module, and the frame 600 can be positioned and direct impact between the optical film 500 and the frame 600 can be possibly reduced. In this embodiment, when the ambient temperature is at room temperature, the side 510 of the optical film 500 is against the surface 103 of the block 10, and the inner wall surface 610 of the frame 600 is against the surface 101 of the block 10. When the ambient temperature increases, for example, exceeds the melting point of the phase change material 300, the phase change material 300 will gradually change to the melted state (e.g. liquid state) or semi-solid semi-liquid state to accommodate the expansion of the optical film 500 and reduce the possibility of the optical film 500 bending or arching. When the ambient temperature drops below the melting point of the phase change material 300, the optical film 500 contacts, and the capsule 100 returns to its original shape and the phase change material 300 solidifies into its original shape, so as to provide the positioning effect.

FIG. 8 is a schematic view of another embodiment of the display device. In this embodiment, the display device includes the display panel 700, the frame 600, and at least one block 10. The display device may have the frame 600 described above, wherein the frame 600 includes the back frame 850, the front frame 860, and the support 602 for supporting the display panel 700. The display panel 700, the support 602, and the block 10 are disposed in the space defined by the back frame 850 and the front frame 860. Similar to FIG. 7, the frame 600 at least partially encloses the accommodation area 830, and the display panel 700 is partially accommodated in the accommodation area 830. The support 602 can be a portion of the back frame 850 or a portion of the front frame 860. In another embodiment, the frame 600 of the display device may optionally include only one of the front frame 860 and the back frame 850, instead of having the front frame 860 and the back frame 850 at the same time. The display panel 700 includes a pair of substrates 711 and 712 and a display medium 730 sandwiched between the pair of substrates 711 and 712. According to practical applications, the display medium 730 can be liquid crystal molecules, organic light-emitting diodes, inorganic light-emitting diodes, quantum dot light-emitting diodes, electrophoretic capsules, or any other suitable materials that can be used for displaying images. The optical film 500 can be disposed under the display panel 700. The light source (not shown) is disposed on at least one side of the optical film 500, but not limited thereto. In another embodiment, the light source (not shown) is disposed under the optical film 500. In this embodiment, the block 10 can be disposed between the display panel 700 and the frame 600. For example, the block 10 is disposed between the side 750 of the display panel 700 and the inner wall surface 810 of the frame 600, so the surfaces 101 and 103 of the block 10 face the inner wall surface 810 of the frame 600 and the side 750 of the display panel 700, respectively. Moreover, the block 10 can also be disposed between the substrate 711 (or the substrate 712) and the frame 600. With the disposition of the blocks 10, the relative location of the display panel 700 and the frame 600 can be positioned and direct impact between the display panel 700 and the frame 600 can be possibly reduced. The inner wall surface 810 can be the inner surface of the back frame 850 or the front frame 860, but not limited thereto. In this embodiment, when the ambient temperature is at room temperature, the side 750 of the display panel 700 is against the surface 103 of the block 10, and the inner wall surface 810 of the frame 600 is against the surface 101 of the block 10. When the ambient temperature increases, for example, exceeds the melting point of the phase change material 300, the display panel 700 will thermally expand, and the phase change material 300 will gradually change to the melted state (e.g. liquid state) or semi-solid semi-liquid state to accommodate the expansion of the display panel 700 and reduce the possibility of the display panel 700 bending or arching. When the ambient temperature drops below the melting point of the phase change material 300, the display panel 700 contacts, and the capsule 100 returns to its original shape and the phase change material 300 solidifies into its original shape, so as to provide the positioning effect.

FIG. 9 is a schematic view of another embodiment of the display device. In this embodiment, the display device is substantially same as FIGS. 7 and 8 and will not elaborate hereinafter. A plurality of blocks 10 can be disposed between the side 510 of the optical film 500 and the inner wall surface 610 of the support 602 and between the side 750 of the display panel 700 and the inner wall surface 810 of the frame 600, wherein the inner wall surface 810 can be the inner surface of the back frame 850 or the front frame 860, or the inner wall surface 610 can be the inner surface of the back frame 850 or the front frame 860, but not limited thereto. With the disposition of the blocks 10, the relative location of the optical film 500 and the frame 600 as well as the relative location of the display panel 700 and the frame 600 can be positioned. As such, when the ambient temperature increases, for example, exceeds the melting point of the phase change material 300, the phase change material 300 will gradually change to the melted state (e.g. liquid state) or semi-solid semi-liquid state to accommodate the expansion of the optical film 500 and the display panel 700 and reduce the possibility of the optical film 500 and the display panel 700 bending or arching. When the ambient temperature drops below the melting point of the phase change material 300, the capsule 100 returns to its original shape and the phase change material 300 solidifies into its original shape, so as to provide the positioning effect.

Although the preferred embodiments of present disclosure have been described herein, the above description is merely illustrative. The preferred embodiments disclosed will not limit the scope of the present disclosure. Further modification of the disclosure herein disclosed will occur to those skilled in the respective arts and all such modifications are deemed to be within the scope of the disclosure as defined by the appended claims.

What is claimed is:

1. A block, comprising:
a capsule enclosing a cavity, the capsule at least partially made of an elastic material; and
a phase change material disposed in the cavity, the phase change material having a melting point lower than a melting point of the elastic material, the phase change material having a shape varying with deformation of the capsule.

2. The block of claim 1, wherein the phase change material is selected from organic phase change materials.

3. The block of claim 2, wherein the phase change material is selected from one of paraffin or aliphatic acids.

4. The block of claim 1, wherein the phase change material is selected from inorganic phase change materials.

5. The block of claim 4, wherein the phase change material is selected from salt hydrates.

6. The block of claim 1, wherein the elastic material has an elastic modulus smaller than 0.1 GPa and greater than 0 GPa.

7. The block of claim 6, wherein the elastic modulus of the elastic material is between 0.01 GPa and 0.1 GPa.

8. The block of claim 1, wherein the capsule has a tensile strength between 0.01 GPa and 1 GPa.

9. The block of claim 1, wherein when the phase change material is in solid state, the phase change material has an elastic modulus larger than an elastic modulus of the elastic material.

10. The block of claim 1, wherein the melting point of the phase change material is between 50° C. and 150° C.

11. The block of claim 1, wherein the phase change material changes from solid state to liquid state or from liquid state to solid state as temperature changes.

12. The block of claim 1, wherein the phase change material is sealed within the capsule.

13. A backlight module, comprising:
an optical film;
a frame at least partially surrounding a side of the optical film; and
at least one block disposed between the side of the optical film and the frame, wherein at least one block comprises:
a capsule enclosing a cavity, the capsule at least partially made of an elastic material; and
a phase change material disposed in the cavity, the phase change material having a melting point lower than a melting point of the elastic material, the phase change material having a shape varying with deformation of the capsule.

14. The backlight module of claim 13, wherein the optical film comprises one of a light guide plate, a diffusion plate, and a glass substrate.

15. A display device, comprising:
a display panel comprising a pair of substrates and a display medium sandwiched between the pair of substrates;
a frame having an accommodation area for accommodating the display panel; and
at least one block disposed between the display panel and the frame, wherein at least one block comprises:
a capsule enclosing a cavity, the capsule at least partially made of an elastic material; and
a phase change material disposed in the cavity, the phase change material having a melting point lower than a melting point of the elastic material, the phase change material having a shape varying with deformation of the capsule.

16. The display device of claim 15, wherein the at least one block is located between a side of one of the pair of substrates and the frame.

17. The display device of claim 15, further comprising a light source for providing light to the display panel.
